(19) United States
(12) Patent Application Publication
(10) Pub. No.: US 2014/0046652 A1
(43) Pub. Date: Feb. 13, 2014

(54) CAPTURING DEVICE AND METHOD OF CAPTURING WORDS FOR TRANSLATION USING THE CAPTURING DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: YAN LI, Shenzhen (CN)

(21) Appl. No.: 13/924,650

(22) Filed: Jun. 24, 2013

(30) Foreign Application Priority Data
Aug. 7, 2012 (CN) 2012102780333

(51) Int. Cl. G06F 17/28

(52) U.S. Cl. CPC G06F 17/28
USPC 704/2

(57) ABSTRACT

A capturing device of capturing words for translation, using the capturing device, the capturing device includes a light source behind a shield case that emits colored light to cover target words to be translated, and the shield case that shields colored light. The capturing device further includes a collection device that captures an image including the target words. A firmware in the capturing device recognizes the target words, converts the recognized words into corresponding characters, and transmits the converted characters to an electronic device to be translated.

### BACKGROUND

1. Technical Field

Embodiments of the present disclosure relate to word reorganization technology, and particularly to a capturing device and a method of capturing words for translation using the capturing device.

2. Description of Related Art

Translation is required for reading or studying in different languages. In a traditional method, a user needs to input words manually into translation software or an electronic dictionary to query translations of the words by a keyboard, a virtual keyboard, or by handwriting. Thus, it is inefficient for users to acquire translation results when querying translations of the words by inputting the words frequently. An electronic pen-shaped scanner can scan printed text and provide instantaneous word-by-word translation. However, the electronic pen-shaped scanner has strict requirements on fonts of the words in the printed text. If the words are too large or too small, identification efficacy of the words may be affected. Furthermore, it is also inconvenient to use the electronic pen-shaped scanner by scanning and translating words one by one.

### BRIEF DESCRIPTION OF THE DRAWINGS

FIG. 1 is a schematic diagram of one embodiment of a capturing device and an electronic device.

FIG. 2 is a structure diagram of one embodiment of the capturing device in FIG. 1.

FIG. 3 is a block diagram of one embodiment of the capturing device and the electronic device in FIG. 1.

FIG. 4 is a block diagram of one embodiment of function modules of a firmware in the capturing device in FIG. 3.

FIG. 5 is a flowchart illustrating one embodiment of a method for executing the translation using the capturing device in FIG. 2.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

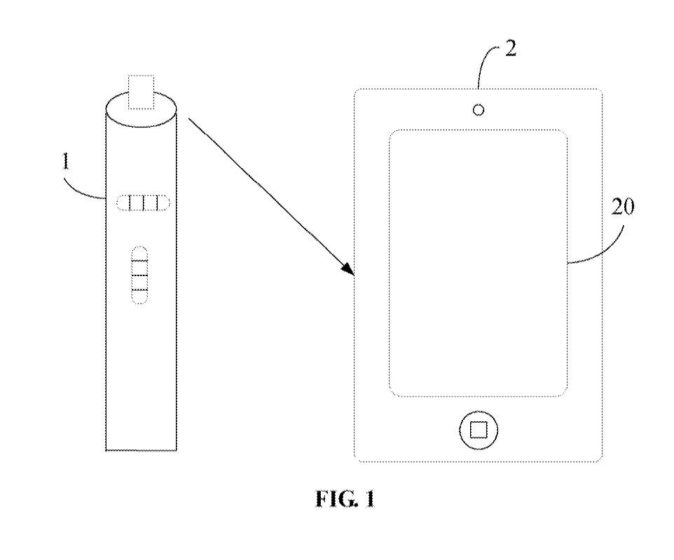

FIG. 1 is a schematic diagram of one embodiment of a capturing device 1 and an electronic device 2. The capturing device 1 communicates with the electronic device 2 through a wireless network (e.g. BLUETOOTH®). The electronic device 2 includes a display screen 20. The electronic device 2 may be a personal computer or a mobile terminal (e.g. a mobile phone).

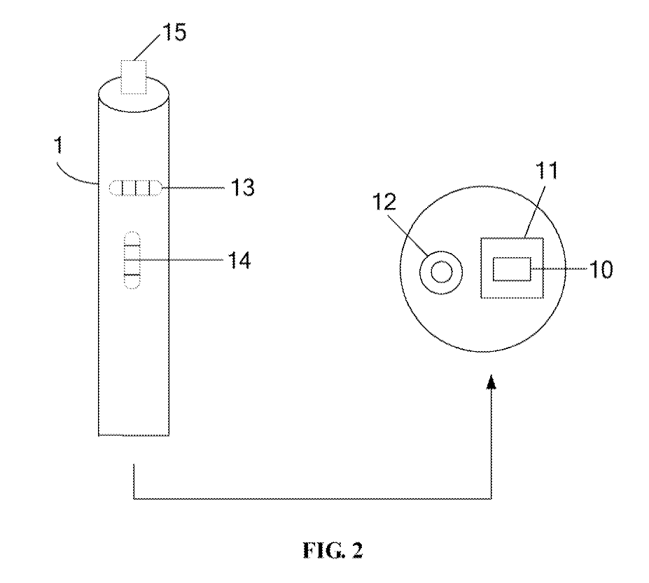

FIG. 2 is a structure diagram of one embodiment of the capturing device 1 in FIG. 1. In one embodiment, a shape of the capturing device 1 may be columnar like a pen. The capturing device 1 includes a shielding case 11 and a collection device 12 on one end of the capturing device 1 (on the same plane of the capturing device 1). The capturing device 1 further includes a light source 10 located behind the shield case 11. The light source 10 can emit colored light to cover target words in text (e.g. printed text) to be translated. The shielding case 11 can shield the colored light of the light source 10 to control a size of area covered by the colored light. The collection device 12 may be a camera for aiming at a text including a plurality of words to be translated and capturing an image including the target words to be translated.

A vertical adjustor 13 and a horizontal adjustor 14 (e.g, slide buttons) are installed on one side of the capturing device 1. Both of the vertical adjustor 13 and the horizontal adjustor 14 are connected to the shield case 11, for controlling a vertical and a horizontal opening or closing of the shield case 11.

In one embodiment, the vertical adjustor 13 and the horizontal adjustor 14 may be rolling adjusting wheels. The vertical opening or closing of the shield case 11 can be adjusted by scrolling up or down the vertical adjustor 13. The horizontal opening or closing of the shield case 11 can be adjusted by scrolling left or right the horizontal adjustor 14. In another embodiment, the vertical adjustor 13 and the horizontal adjustor 14 may be push-button adjusting wheels. The vertical adjustor 13 may include an up button and a down button for adjusting the vertical opening or closing of the shield case 11. The horizontal adjustor 14 may include a left button and a right button for adjusting the horizontal opening or for closing of the shield case 11.

A button 15 is installed on the other end of the capturing device 1, to enable the collection device 12. When the colored light emitted by the light source 10 covers the target words to be translated, the collection device 12 is enabled to capture an image including the target words by pressing down of the button 15. In one embodiment, when the colored light just covers the target words, a covered area of the target words is equal to a minimum bounding box of the target words. A size of the covered area of the target words is controlled by adjusting the vertical adjustor 13 and the horizontal adjustor 14.

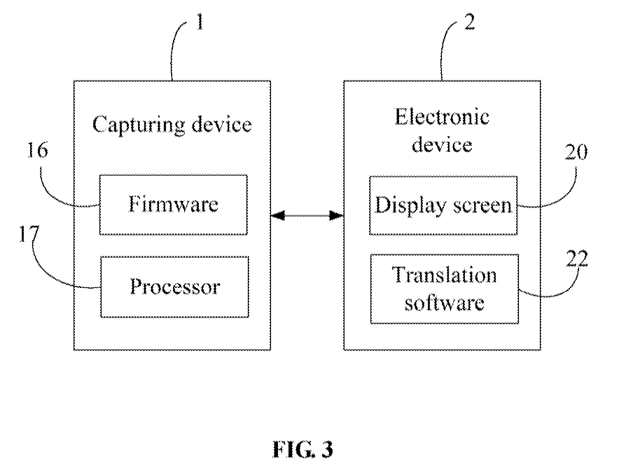

FIG. 3 is a block diagram of one embodiment of the capturing device and the electronic device. The capturing device 1 further includes a circuit (not shown in FIG. 3) to enable the light source 10 to emit the colored light, a firmware 16, and at least one processor 17. The firmware 16 includes one or more modules to convert the target words covered by the colored light in the image to be corresponding characters(e.g. using optical character recognition technology), and to send the converted characters to the electronic device 2. The at least one processor 17 executes one or more computerized codes and other applications for the capturing device 1 to provide the functions of firmware 16.

The electronic device 2 further includes translation software 22. The translation software 22 translates the converted characters by querying a local database or a network database (not shown in FIG. 3), and displays a translation result on the display screen 20. In one embodiment, the translation software 22 can translate character in one natural language to a desired natural language preset according to user requirements. For example, the translation software 2 translates characters in English to characters in Chinese.

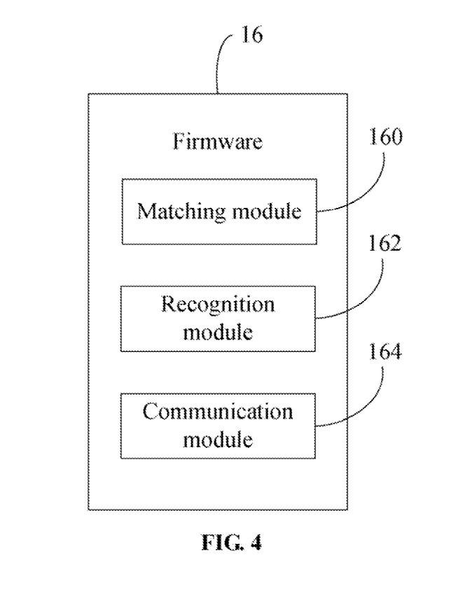

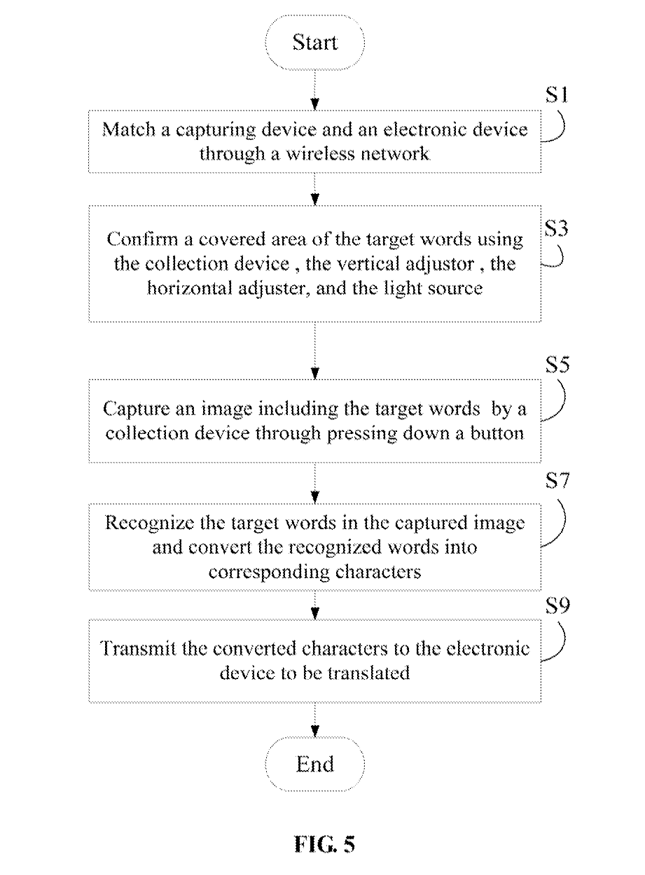

FIG. 4 is a block diagram of one embodiment of function modules of a firmware in the capturing device in FIG. 3. The firmware 16 includes a matching module 160, a recognition module 162, and a communication module 164. The one or more modules may comprise computerized instructions in the form of one or more programs that are stored in the firmware 16 and executed by the processor 17 to provide functions of the modules 160, 162, and 164. Details of each of the modules are given in FIG. 5.

The matching module 160 matches the capturing device 1 and the electronic device 2 through the wireless network. After the capturing device 1 has matched the electronic device 2, the capturing device 1 sends characters to the electronic device 2.

The recognition module 162 recognizes the target words covered by the colored light from the image captured by the collected device 12, and converts the recognized words into corresponding characters (e.g. literal codes of the words).

The communication module 164 transmits the converted characters to the electronic device 2 for translation. The electronic device 2 uses the translation software 22 to translate the received characters by querying the local database or the network database, and displays a translation result on the display screen 20.

FIG. 5 is a flowchart illustrating one embodiment of a method for executing the capturing and translation using the capturing device in FIG. 2. Depending on the embodiment, additional steps may be added, others deleted, and the ordering of the steps may be changed.

In step S1, the matching module 160 matches the capturing device 1 and the electronic device 2 through the wireless network. After the capturing device 1 has matched the electronic device 2, the capturing device 1 sends characters to the electronic device 2.

In step S3, a covered area of the target words is confirmed using the collection device 12, the vertical adjustor 13, the horizontal adjuster 14 and the light source 10. In one embodiment, after the collection device 12 aims at a text including a plurality of words to be translated, the colored light emitted by the light source 10 covers the target words by controlling the vertical and the horizontal opening or closing of the shield case 11 using the vertical adjustor 13 and the horizontal adjustor 14. When the colored light is controlled to just cover the target words, the covered area of the target words may be equal to the minimum bounding box of the target words. According to the covered area covered by the colored light, users can clearly know what words that needs to be translated.

In step S5, the collection device 12 captures an image including the target words by pressing down the button 15.

In step S7, the recognition module 162 recognizes the target words in the captured image, and converts the recognized words into corresponding characters (e.g. literal codes of the words).

In step S9, the communication module 164 transmits the converted characters to the electronic device 2 for translation. The electronic device 2 uses the translation software 22 to translate the received characters and display a translation result on the display screen 20.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A capturing device in communication with an electronic device, the capturing device comprising:
a light source located behind a shield case of the capturing device that emits colored light to cover target words to be translated;
the shield case that controls a size of area covered by the colored light;
a collection device that captures an image comprising the target words; and
a firmware that recognizes the target words in the captured image, converts the recognized words into corresponding characters, and transmits the converted characters to the electronic device for translation.

2. The capturing device as described in claim 1, wherein the collection device captures the image when a covered area of the target words is equal to a minimum bounding box of the target words.

3. The capturing device as described in claim 2, further comprising:
a vertical adjustor that adjusts a vertical opening and a vertical closing of the shield case; and
a horizontal adjustor that adjusts a horizontal opening and a horizontal closing of the shield case, a size of the covered area of the target words being controlled by adjusting the vertical adjustor and the horizontal adjustor.

4. The capturing device as described in claim 3, wherein the vertical adjustor and the horizontal adjustor are rolling adjusting wheels or push-button adjusting wheels.

5. The capturing device as described in claim 1, wherein the converted characters are translated by translation software in the electronic device, and a translation result of the converted characters is displayed on a display screen of the electronic device.

6. The capturing device as described in claim 1, further comprising:
a button that enables the collection device to capture the image.

7. The capturing device as described in claim 1, wherein the collection device and the shield case are in the in a same plane of the capturing device.

8. The capturing device as described in claim 1, wherein the firmware further matches the capturing device and the electronic device through a wireless network.

9. A method of capturing words for translation using a capturing device, the capturing device in communication with an electronic device, the method comprising:
emitting colored light to cover target words to be translated by a light source located behind a shield case of the capturing device;
capturing an image comprising the target words by a collection device of the capturing device;
recognizing the target words from the captured image, converting the recognized words into corresponding characters;
transmitting the converted characters to an electronic device for translation.

10. The method as described in claim 9, wherein the collection device captures the image comprising the target words when a covered area of the target words is equal to a minimum bounding box of the target words.

11. The method as described in claim 10, wherein a size of the covered area of the target words is controlling by adjusting a vertical adjustor and a horizontal adjustor of the capturing device, the vertical adjustor that adjusts a vertical opening and a vertical closing of the shield case, the horizontal adjustor that adjusts a horizontal opening and a horizontal closing of the shield case.

12. The method as claimed in claim 11, wherein the vertical adjustor and the horizontal adjustor are rolling adjusting wheels or push-button adjusting wheels.

13. The method as claimed in claim 9, wherein the converted characters are translated by translation software in the electronic device, and a translation result of the converted characters is displayed on a display screen of the electronic device.

14. The method as claimed in claim 9, wherein the collection device is enabled to capture the image by a button of the capturing device.

15. The method as claimed in claim 9, wherein the collection device and the shield case are in the in a same plane of the capturing device.

16. The method as claimed in claim 9, further comprising:
matching the capturing device and the electronic device through a wireless network.
